(19) United States
(12) Patent Application Publication
(10) Pub. No.: US 2003/0225627 A1
(43) Pub. Date: Dec. 4, 2003

(54) Method for retail distribution of medical products

(76) Inventor: Clarence Mast, Tunhannock, PA (US)

Correspondence Address: Robert S. Lipton, LIPTON, WEINBERGER & HUSICK, 201 North Jackson Street, P. O. Box 934, Media, PA, 19063-0934, US

(21) Appl. No.: 10/160,410

(22) Filed: Jun. 3, 2002

(51) Int. Cl. G06F 17/60

(52) U.S. Cl. 705/26

(57) ABSTRACT

The invention is a method for coordinating the retail distribution of pharmaceuticals and durable medical equipment. A health care provider or patient selects a pharmacy or durable medical equipment supplier from a database. The health care provider or his designee electronically transmits a prescription to the pharmacy or durable medical equipment supplier. The pharmacy or durable medical equipment supplier fills the prescription and collects payment from patient and patient's insurer. The health care provider manages the prescription after the prescription is transmitted but before the prescription is filled by the pharmacy.

### BACKGROUND OF THE INVENTION

1. Field of the Invention

The invention relates to the distribution of medical products including pharmaceuticals and durable medical equipment (“DME”). The invention is a method for coordination of that distribution using a computer network such as the Internet. A doctor or patient may locate a pharmacy or other supplier. The doctor may manage a prescription for a pharmaceutical or DME electronically after the prescription is written but before the prescription is filled by canceling the prescription, allowing the prescription to remain in effect, or monitoring patient purchase of the pharmaceutical.

2. Description of the Related Art

The distribution chain for pharmaceuticals and durable medical equipment (“DME”) is generally manual. A physician writes a paper prescription for a drug. A patient delivers the paper prescription to a local (brick-and-mortar) pharmacy. The pharmacy fills the prescription and receives partial payment from the patient. The pharmacy presents a claim to patient's insurance company for the remainder of the payment due.

Various approaches exist in the prior art to making the manual process more efficient. For example, mail order pharmacies have existed for several years. In the business model used by mail order pharmacies, the patient mails a paper prescription to the pharmacy and the pharmacy mails drugs to the patient. The mail order pharmacies do not provide the doctor involvement in filling and monitoring of the prescription provided by the present invention and do not provide the opportunity for electronic prescriptions and renewal of prescriptions provided by the present invention.

More recently, Internet pharmacies have come into existence. Internet pharmacies receive orders from patients over the internet and deliver drugs by mail. An Internet pharmacy may be a full-line pharmacy handling substantially all governmentally approved prescription medications or may sell only a few medications. Some Internet pharmacies process insurance claims in the same manner as a bricks-and-mortar pharmacy. Other Internet pharmacies do not deal with insurance claims at all.

Some Internet pharmacies employ a staff physician who prescribes medication based on patient entries on a computer-generated electronic form. The physician has no contact with the patient other than by reading words on a form. The physician does not follow up with the patient. Because of the very limited patient care involved, such Internet pharmacies generally stock a limited number of relatively low-risk drugs for non-life threatening conditions, such as sexual dysfunction or hair loss. Some Internet pharmacies commonly provide a referral fee to anyone, such as a doctor, referring business to the internet pharmacy.

The Internet pharmacies do not provide for the choice of suppliers inherent in the present invention. The Internet pharmacies also do not provide for the management of prescriptions under the immediate care of a doctor who actually has examined the patient.

Several prior art patents have addressed the delivery of pharmaceuticals.

U.S. Pat. No. 5,797,515 to Liff issued Aug. 25, 1998 reveals a vending machine for drug containers. The vending machine is controlled by a computer. The machine is placed in a doctor's office and accessed by the patient. A central service center monitors several vending machines. Liff does not provide for choice of suppliers of the present invention.

U.S. Pat. No. 5,832,497 to Taylor issued Nov. 13, 1998 teaches an online database of jobs and resumes. Taylor provides for searches to match jobs with job seekers. Taylor does not provide for writing or filling of prescriptions for drugs or DME and does not provide for physician management of prescriptions after the prescription is written.

U.S. Pat. No. 5,845,255 to Mayaud dated Dec. 1, 1998 teaches a computerized prescription writing and transmission system using a network. Mayaud provides the physician with information to write the best prescription for the patient, including information on available drugs, patient history and drugs covered by the patient's insurance. Mayaud does not provide for electronic transmission of a prescription to a pharmacy and does not provide for selection of a pharmacy or DME supplier by a physician or patient. Mayaud also does not provide for management of the prescription by the doctor after the prescription is written.

U.S. Pat. No. 5,963,453 to East issued Oct. 5, 1999 relates to the automated filling of pill bottles at a pharmacy. East does not relate to the process of transmitting the prescription to the pharmacy and does not relate to doctor management of the prescription.

U.S. Pat. No. 5,982,863 to Smiley issued Nov. 9, 1999 teaches a voice appointment system for use by physicians. A caller can set an appointment by speaking to voice recognition software rather than to a live assistant. Smiley does not relate to selecting a pharmacy or filling prescriptions.

U.S. Pat. No. 6,014,631 to Teagarden issued Jan. 11, 2000 teaches a computerized system of determining whether medications are appropriate. An insurance company using the Teagarden invention makes a detailed evaluation of a patient's medical condition, lifestyle and over the counter drugs. The Teagarden invention does not relate to selecting a pharmacy or electronically transmitting a prescription to a pharmacy.

U.S. Pat. No. 6,202,923 to Boyer issued Mar. 20, 2001 is a system for use in a pharmacy to avoid error. Boyer does not relate to selection of a pharmacy by a doctor or patient and does not relate to electronic transmission of a prescription to a pharmacy by a doctor or to management of the prescription by the doctor.

### SUMMARY OF THE INVENTION

The present invention is a method for coordinating the retail distribution of medical products, including pharmaceuticals or durable medical equipment (“DME”), from a pharmacy or DME supplier using the Internet. A doctor or other health care provider authorized by law to write prescriptions utilizes a computer network such as the Internet to write a prescription for pharmaceuticals or DME and uses the computer network to manage the prescription after issuance, including submitting the prescription to a pharmacy or DME supplier, canceling the prescription, and monitoring patient compliance, as appropriate.

For purposes of this application, the term “pharmaceutical” means any material intended for treatment of a health-related condition of a human being or animal and which by law may be dispensed only by prescription. The term ‘durable medical equipment’ means equipment to treat a human or animal health condition, but excluding pharmaceuticals. Examples of DME include a wheelchair or a crutch.

In the method of the present invention, a patient queries a computer database through an internet web site to locate a suitable health care provider, such as a doctor or dentist. The doctor examines the patient and determines medications or DME appropriate to the patient's medical condition. The doctor or the patient queries the Internet web site and searches a database to locate a pharmacy or durable medical equipment dealer offering appropriate services and in a convenient physical location. The doctor electronically transmits the prescription to the selected pharmacy or DME supplier. The doctor may manage the prescription electronically, including canceling the prescription or monitoring patient compliance, as appropriate. The pharmacy or DME supplier may submit requests to refill the prescription electronically to the doctor, who will either grant or deny the request.

Insurance information may be submitted to the pharmacy or DME supplier electronically either by the doctor or by the patient. Insurance information may reside in computer memory to render unneccessary reentry of that information. If some or all of the cost of the prescribed drug or DME is not covered by insurance, as by a patient co-pay, the patient may provide for payment of the co-pay amount by credit card though the Internet web site. A commission on a sale may be paid to the operator of the Internet web site for providing transaction facilitation services. A commission on a sale may be provided to a doctor or other referring person. Payment of such a commission should be in compliance with any laws and ethical standards which apply to the recipient.

### BRIEF DESCRIPTION OF THE DRAWINGS

FIG. 1 is an overview diagram of the present invention.

FIG. 2 is a diagram of communication flow of the present invention.

FIG. 3 is a flow diagram of the initial choices offered to a user of the Internet embodiment of the invention.

FIG. 4 is a flow diagram of the choices offered to a patient.

FIG. 5 is a flow diagram for choices offered to a health care provider.

FIG. 6 is a flow diagram of the choices offered to the health care location manager.

FIG. 7 is a flow diagram of the process of managing prescription refills by the doctor.

FIG. 8 is a flow diagram showing doctor or patient selection of durable medical equipment.

FIG. 9 is a flow diagram showing choices offered to the pharmacy.

FIG. 10 is a flow diagram showing choices offered to the Pharmacy location manager.

FIG. 11 is a flow diagram showing the process of obtaining prescription refill approval by the pharmacy.

FIG. 12 is a flow diagram of the choices offered to the durable medical equipment supplier.

FIG. 13 is a flow diagram of the choices offered the DME location manager.

FIG. 14 is flow diagram of choices available to the store manager.

### DESCRIPTION OF AN EMBODIMENT

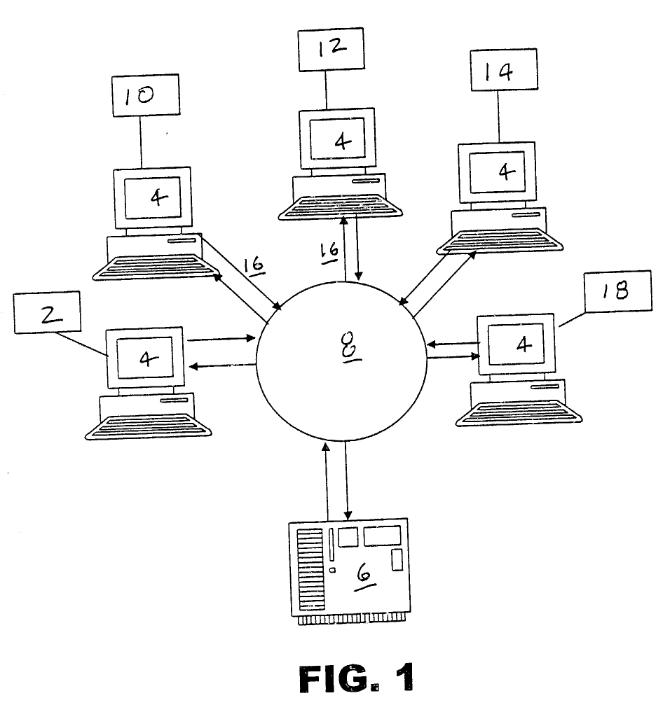

FIG. 1 is an overview diagram of the present invention. A patient 2 utilizes a client computer 4 to communicate with a server computer 6 over a computer network, which may be the Internet 8. The patient 2, through a client computer 4, queries the server computer 6 to locate a healthcare provider 10 providing a specified service in a specified location. The server computer 6 conducts an appropriate search of a database resident in the memory of the server computer 6 and provides the patient 2 with a list of suitable healthcare providers 10, who may be physicians.

The patient 2 visits the health care provider 10, who determines that pharmaceuticals or durable medical equipment (“DME”) are appropriate to the care of the patient 2. The patient 2 or health care provider 10 selects a pharmacy 12 and medical equipment supplier 14 to supply the pharmaceuticals and DME to the patient 2. The health care provider 10, patient 2, DME supplier 14 and pharmacy 12 each communicates by transmitting data from a client computer 4 through the Internet 6 to a server computer 6 programmed to display to client computers 4 an Internet web site specific to the purpose. The web site provides a secure avenue for the exchange of sensitive medical information.

The health care provider 10 electronically transmits a prescription 16 for a pharmaceutical or DME to a pharmacy 12 or DME supplier 14 and may manage the prescription 16 after the prescription 16 is transmitted through selection of the pharmacy 12 or DME supplier 14, through canceling of the prescription 16 and through monitoring of patient 2 compliance, as appropriate. Because the patient 2 is under the immediate care of the health care provider 10, the web site is a suitable medium for distributing drugs for all purposes, including treatment of life threatening conditions. The web site further provides a structured means for the health care provider 10 to receive electronic (rather than telephonic) requests for prescription 16 refills.

The web site also may host a store 18 from which any user may search for or browse items for sale and may purchase such items.

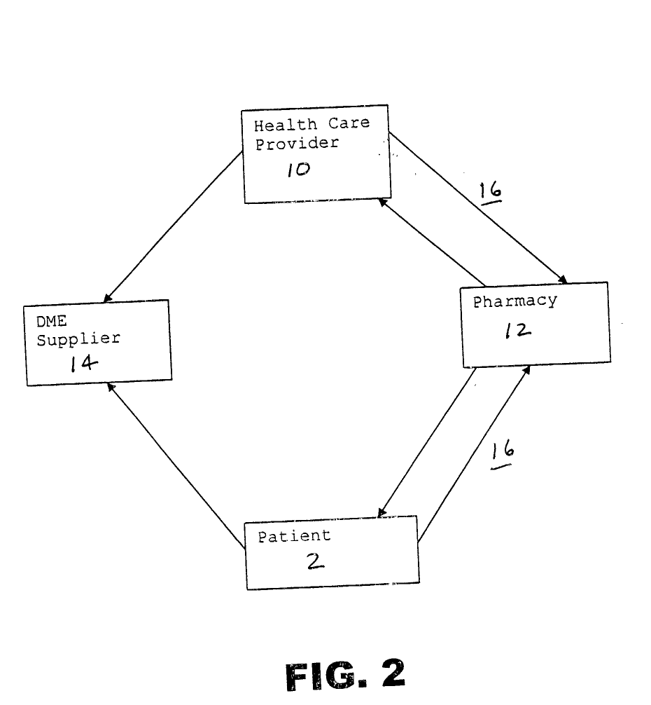

FIG. 2 presents a diagram of the major communication flow of the present invention. The health care provider communicates prescriptions 16 and prescription 16 refills to the pharmacy 12. The health care provider 10 also orders DME through the DME supplier 14. Also from FIG. 2, the pharmacy 12 provides filled prescriptions 16 to the patient 2. The pharmacy 12 submits prescription 16 refill requests to the health care provider 10. The pharmacy 12 receives prescriptions 16 from the health care provider 10 or the patient 2. The pharmacy 12 may receive the patient's 2 insurance information from the web site and may receive patient's 2 credit card information from the web site to secure any co-payment that may be due.

From FIG. 2, the patient 2 transmits prescriptions 16 to the pharmacy 12 or DME supplier 14 and received the filled prescriptions 16 from the pharmacy 12 or DME supplier 14. The patient 2 may transmit insurance information to the pharmacy 12, DME supplier 14 or health care provider 10.

Also from FIG. 2, the DME supplier 14 receives an order for medical equipment from the health care provider 10 or patient 2 and provides the DME to the patient. The DME supplier 14 may receive patient's insurance information from the web site to facilitate payment and may receive credit card information from the web site to pay for portions of the cost not paid by patient's 2 insurance.

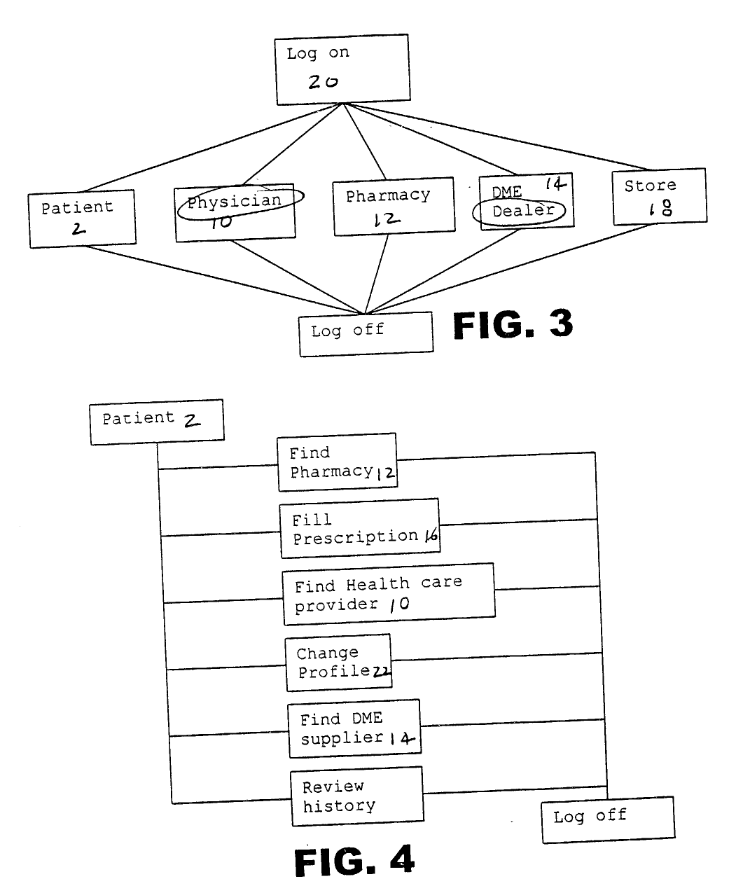

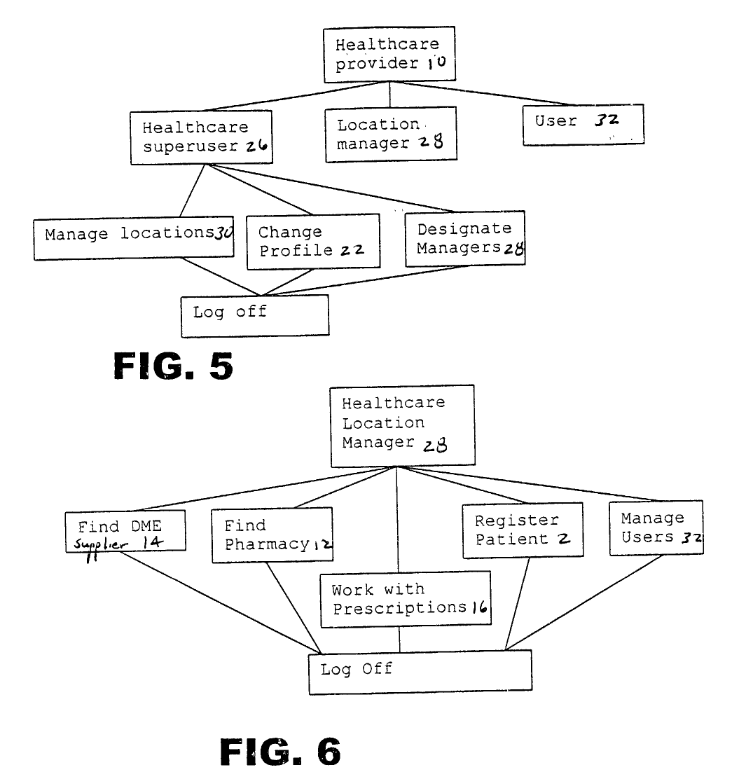

FIG. 3 illustrates the choices presented to a person accessing the web site over the Internet 8. The person must log on 20 and identify him or herself as a patient 2, health care provider 10, pharmacy 12, DME supplier 14 or store 18. The store 18 is an internet store selling non-prescription health-related items. Once the person identifies him or herself as belonging to one of the above categories, the user is presented with additional choices.

FIG. 4 shows the choices presented to a user who identifies him or herself as a patient 2. The patient 2 may elect to find a DME supplier 14, find a pharmacy 12, find a health care provider 10, fill a prescription 16, change his or her profile or review his or her transaction history. If the patient 2 elects to find a DME supplier 14, the patient 2 may search a database for DME suppliers 14 based on distance, zip code and DME needed. A list of DME suppliers 14 meeting the patient's 2 criteria is presented to the patient 2, who may then search the DME supplier's 14 inventory and, if desired, place an order with DME supplier 14.

If the patient 2 elects to find a health care provider 10, the patient 2 is allowed to search a database of doctors and other health care providers 2 by zip code, distance and discipline. Any other search criteria also may be used, such as gender, name, hospital or affiliation. The patient 2 is presented with a list of health care providers 10 meeting patient's 2 criteria. Patient 2 then may select a health care provider 10.

Similarly, if the patient 2 elects to find a pharmacy 12, the patient 2 searches a database of pharmacies 12 based on zip code, distance and pharmaceuticals required. Patient 2 may be allowed to search for a pharmacy 2 based on any criteria, including price for the required drug or acceptance of insurance. Once the patient 2 has selected a pharmacy 12, the patient 2 may fill a prescription 16. If the patient 2 is in possession of a paper prescription 16, the patient 2 may transmit the prescription 16 to the pharmacy 12 by any means, including by facsimile transmission or by transmitting a scanned image.

If patient 2 elects to change his or her profile 22, the patient 2 is allowed to modify the patient's 2 identification and background information resident in the computer memory of the server computer 6 maintaining the web site. If patient 2 selects to review his or her transaction history 24, the patient 2 is presented with the patients transaction history 24 on the web site, a record of prescriptions 16 submitted or renewed.

FIG. 6 shows the choices presented to the person identifying him or herself as a health care provider 10 from FIG. 3. Three levels of health care provider 10 are allowed. The health care superuser 26 is the top level administrator in charge of the account for a health care provider 10. The health care superuser 26 may change the profile 22 of the account, may designate health care location managers 28 and may manage locations 30. Each health care location 30 is a separate physical location or practice group under common management. The health care superuser 26 may create subaccounts for separate locations and may appoint health care location managers 28 for those locations 30.

As shown by FIG. 6, health care location managers 28 have such power as is designated by the health care superuser 26. The health care superuser 26 and health care manager 28 may be the same person. The health care manager 28, as designated by the superuser 26, has the authority to manage users 32, to find DME suppliers 14, to find a pharmacy 12, to work with prescriptions 16 and to register a patient 2. Users 32 are members of the health care provider 10 staff and have so much of the power of the health care location manager 28 as is designated by the manager 28. A health care superuser 26, manager 28 or user 32 may be a doctor.

The health care location manager 28, or, if designated, the health care user 32, may work with prescriptions 16, including transmitting a prescription 16 to a pharmacy 12, canceling the prescription 16, and monitoring patient 2 compliance as appropriate.

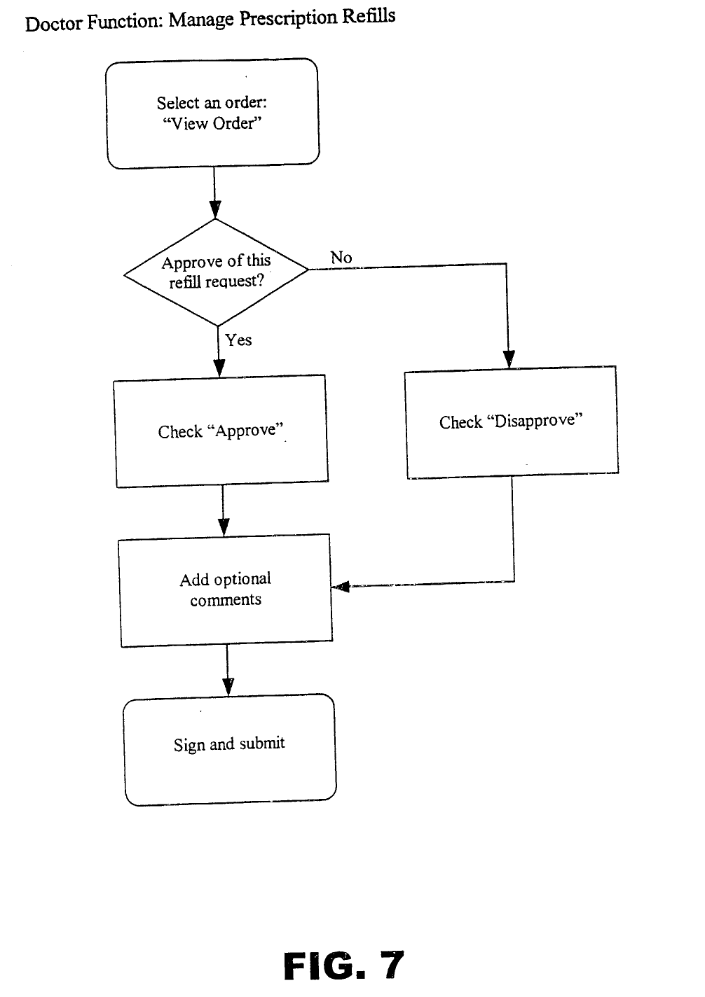

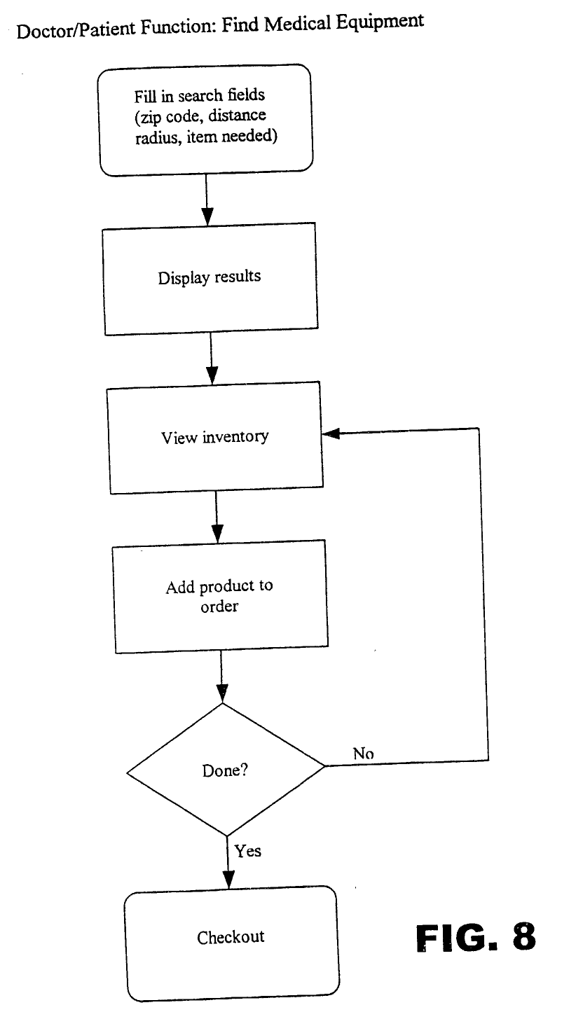

FIG. 7 is a flow chart illustrating the function of the health care manager 28 or user 32 in authorizing that a prescription 16 be refilled on request of the pharmacy 12. FIG. 8 is a flow chart illustrating the functions of the health care location manager 28 or user 32 in finding and ordering DME from a DME supplier 14.

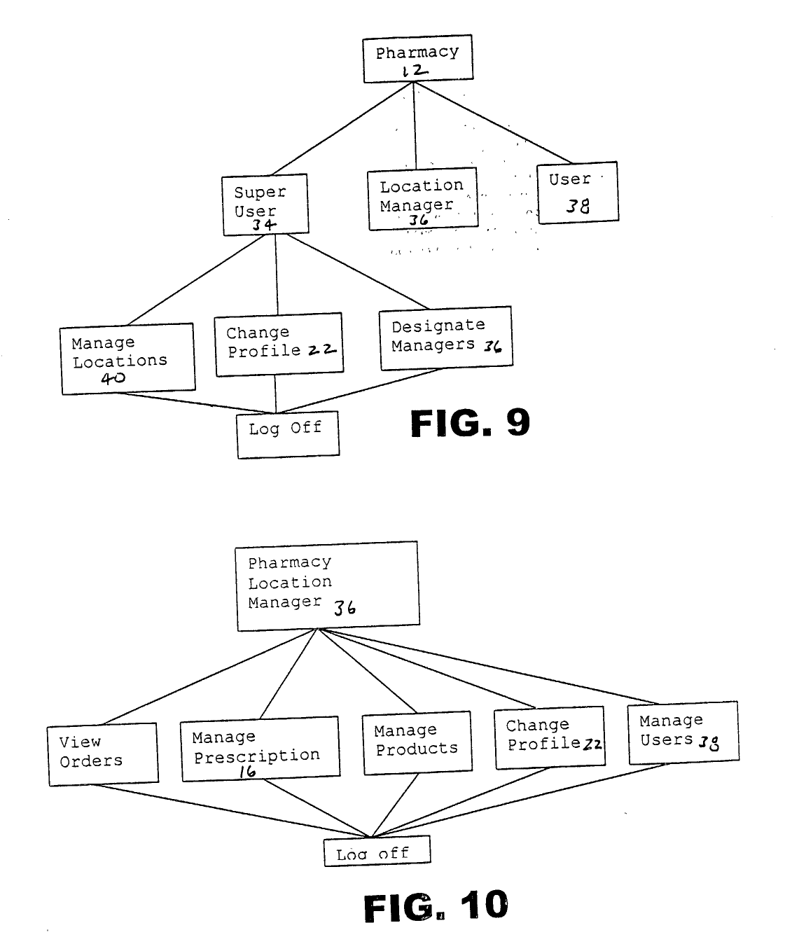

FIG. 9 shows the choices provided to a person identifying him or herself as a pharmacy 12 in the step illustrated by FIG. 3. The person is a pharmacy superuser 34, pharmacy location manager 36 or pharmacy user 38. The pharmacy superuser 34 may change the pharmacy identification and contact information in the profile 22 and manage pharmacy locations 40, which may be separate physical locations or may be other separately administered business units, as designated by the pharmacy superuser 34. The pharmacy superuser 34 also may designate pharmacy location managers 36 for the pharmacy locations 40. The pharmacy location managers 36 have such powers as are designated by the pharmacy superuser 34, including viewing product orders, managing prescriptions 16, managing products and managing pharmacy users 38. Pharmacy users 38 are pharmacy 12 staff delegated authority by the pharmacy location manager 36 to perform any or all of the actions of the pharmacy location manager 36.

The pharmacy location manager 36 manages prescriptions 16 by viewing prescription 16 orders received, modifying or deleting the prescription 16 or adding comments. The orders received by the pharmacy 12 may be integrated automatically into the pharmacy's 12 prescription 16 control system or may be entered manually by the pharmacy location manager 36 or pharmacy user 38. The pharmacy location manager 36 manages products by posting an inventory of goods or services to the web site. The patient 2 or health care provider 10 may browse through the inventory or search for particular items. The health care provider 10 or patient 2 may purchase goods or services in the inventory from the pharmacy 12 through the web site.

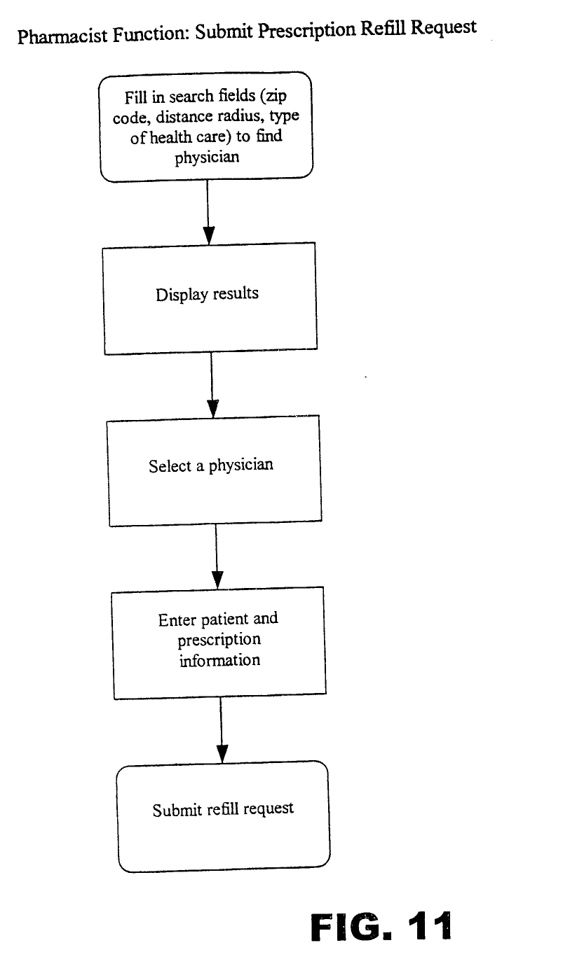

FIG. 11 provides a flow chart of the steps followed by the pharmacy location manager 36 or pharmacy user 38 in submitting a prescription 16 refill request to a health care provider 10.

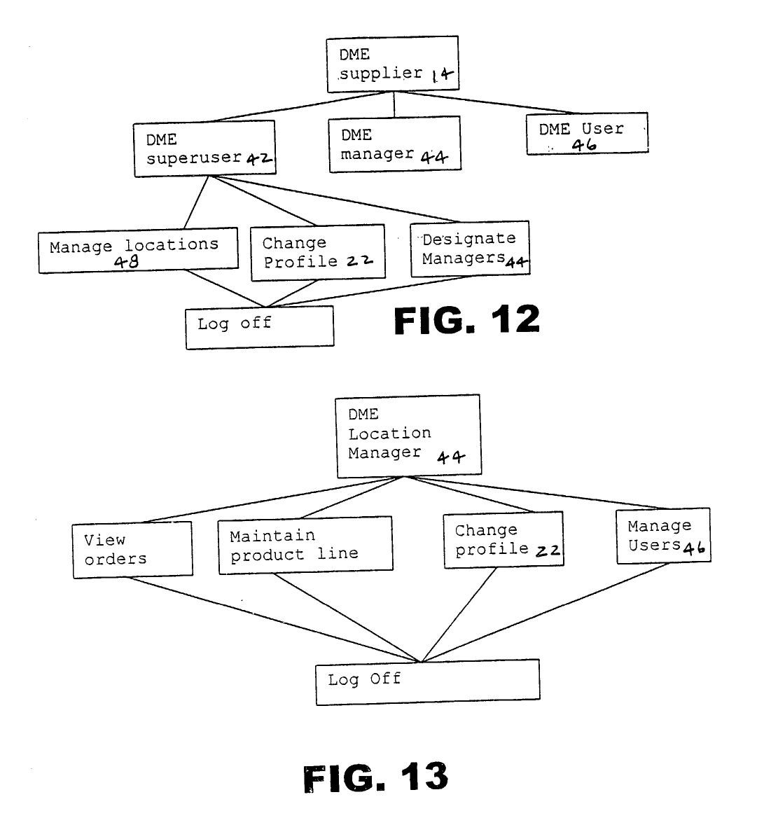

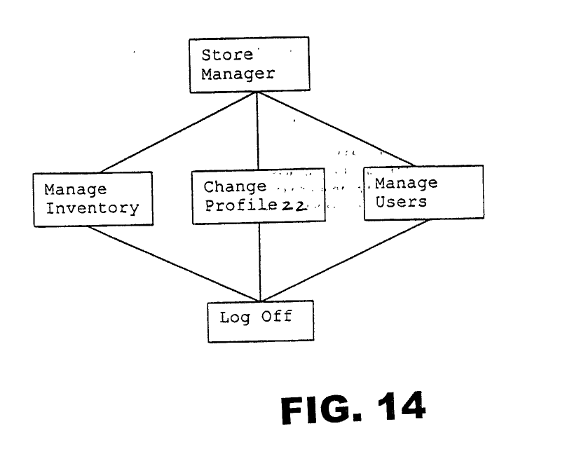

FIG. 12 is a flow chart of options available to a person who identifies him or herself as a DME supplier 14 in response to the query of FIG. 3. The person is a DME superuser 42, DME location manager 44 or DME user 46. The DME superuser 42 is the top level DME administrator and has the power to change the DME supplier's profile 22, including contact and identifying information. The DME superuser 42 also may manage DME supplier locations 48, which may be separate physical locations or may be business units of the DME supplier 14. The DME superuser 42 has the further power to designate DME location managers 44 with operational control over the DME supplier locations 48.

The DME location manager 44 has the power to designate DME users 46 who have some or all of the DME location manager's 44 powers, as designated by the DME location manager 44. The DME location manager 44 or designated DME user 46 may view orders for medical equipment. Each order may be entered automatically in the DME location's 48 inventory control system, or may be entered manually by the DME location manager 44 or designated DME user 46. The DME location manager 44 or designated DME user 46 may maintain the DME location's 48 product line by entering an inventory of available products so that a patient 2 or health care provider 10 may browse or search the inventory.

The DME supplier 14 or pharmacy 12 may compensate the web site operator for orders placed over the web site.

The goods and services offered by a pharmacy 12, DME supplier 14 and store 18 may overlap, and each may provide the goods of the other.

Many different embodiments of the above invention are possible. This application is intended to address all possible embodiments and is limited only as described in the following claims.

I claim:

1. A method for coordinating retail distribution of a medical product comprising the steps of:
a. transmitting a prescription for said medical product electronically by communication over a computer network by a health care provider to a product supplier;
b. managing by said health care provider of said prescription electronically by communication over said computer network.

2. The method of claim 1, said communication over said computer network comprising transmitting a data set from a sending client computer to a server computer and further comprising transmission of said data set from said server computer to a receiving client computer.

3. The method of claim 2, said computer network comprising an Internet.

4. The method of claim 3, said managing of said prescription by said health care provider comprising:
a. instructing by said health care provider to said product supplier to leave said prescription in effect;
b. instructing by said health care provider to said product supplier to cancel said prescription; and
c. monitoring patient compliance, as determined by said health care provider.

5. The method of claim 4, said monitoring of patient compliance comprising monitoring by said health care provider of purchases of said medical product by a patient.

6. The method of claim 5 further comprising selecting by said patient of said health care provider, said selection of said health care provider by said patient comprising the steps of:
a. searching a health care provider database based on health care provider search criteria, said health care provider search criteria comprising a location of said health care provider and an area of practice of said health care provider;
b. selecting from among said health care providers meeting said health care provider search criteria.

7. The method of claim 6, said health care provider database being resident in a computer memory of said server computer.

8. The method of claim 7, said medical product comprising a pharmaceutical product, said product supplier comprising a pharmacy, further comprising the additional step of selecting said pharmacy, said selection of said pharmacy comprising:
a. searching a pharmacy database based on pharmacy search criteria, said pharmacy search criteria comprising a location of said pharmacy and an identity of said pharmaceutical product prescribed, said pharmacy database being resident in said computer memory of said server computer; and
b. selecting from among the pharmacies meeting the pharmacy search criteria.

9. The method of claim 6, said medical product comprising an item of durable medical equipment (“DME”), said product supplier comprising a DME supplier, further comprising the additional step of selecting said DME supplier, said selection of said DME supplier comprising:
a. searching a DME supplier database based on DME supplier search criteria, said DME supplier search criteria comprising a location of said DME supplier and an identity of said item of DME prescribed, said DME supplier database being resident in said computer memory of said server computer; and
b. selecting from among the DME suppliers meeting the DME supplier search criteria.
